(19) United States
(12) Patent Application Publication
(10) Pub. No.: US 2011/0281458 A1
(43) Pub. Date: Nov. 17, 2011

(54) CABLE ASSEMBLY WITH IMPROVED TERMINATING MEANS

(75) Inventors: PING-SHENG SU, New Taipei (TW); XIAO-GANG WU, Kunshan (CN)

(73) Assignee: HON HAI PRECISION INDUSTRY CO., LTD., New Taipei (TW)

(21) Appl. No.: 13/105,932

(22) Filed: May 12, 2011

(30) Foreign Application Priority Data
May 12, 2010 (CN) 201020187763.9

(51) Int. Cl. H01R 24/00; H01R 4/24

(52) U.S. Cl. 439/393; 439/660

(57) ABSTRACT

A cable assembly (1000) includes an insulative housing (11); a plurality of contacts (13) received in the insulative housing, each contact having a mating portion (1311), a retention portion (1312) extending backwardly from the mating portion and a tail portion (1313) extending backwardly from the retention portion, the tail portion (1313) having a tapered end (1316) and at least one cutout (1318) defined thereon; a cable (14) having an insulative jacket (141) and a plurality of wires (142) enclosed by the jacket, each wire having an inner conductor and an insulative layer shielding the inner conductor; and wherein the tail portions of the contacts respectively penetrated into the wires along an axial direction.

### BACKGROUND OF THE INVENTION

1. Field of the Invention

The present invention relates to a cable assembly, especially to a cable assembly with improved terminating means.

2. Description of Related Art

A cable assembly generally refers to a cable connected to a connector. The connector includes an insulative housing, a plurality of contacts mounted to the insulative housing and a cable having a number of wires with inner conductors respectively soldered to the contacts.

However, there are some problems of terminating the wires to the contacts by soldering process. First, the cable should be trimmed, i.e. a front part of a jacket of the cable should be removed away to expose the wires, and then an insulator outside of the corresponding wire should be stripped off so as to expose the inner conductors outside, and then the wires also should be organized as they are always in a mess state. It takes much time to terminate the wires to the contacts by soldering process. In addition, the soldering process may cause environment pollution.

Hence, an improved means for terminating the wires to the contacts is required to overcome the problems of the prior art.

### SUMMARY OF THE INVENTION

An object of the present invention is to provide an improved terminating means for a cable assembly.

Accordingly, to achieve above-mentioned object, a cable assembly comprises an insulative housing; a plurality of contacts received in the insulative housing, each contact having a mating portion, a retention portion extending backwardly from the mating portion and a tail portion extending backwardly from the retention portion, the tail portion having a tapered end and at least one cutout defined thereon; a cable having an insulative jacket and a plurality of wires enclosed by the jacket, each wire having an inner conductor and an insulative layer shielding the inner conductor; and wherein the tail portions of the contacts respectively are penetrated into the wires along an axial direction.

The detailed features of the present invention will be apparent in the detailed description with appropriate reference to the accompanying drawings.

### BRIEF DESCRIPTION OF THE DRAWINGS

FIG. 1 is a perspective assembled view of a cable assembly in accordance with the present invention;

FIG. 2 is an exploded, perspective view of the cable assembly in FIG. 1;

FIG. 3 is similar to FIG. 2, but viewed from other aspect;

FIG. 4 is a partial assembled perspective view of the cable assembly,

FIG. 5 is a cross-section view of the FIG. 1 taken along a line 5-5, and

FIG. 6 is an enlarged view of contacts.

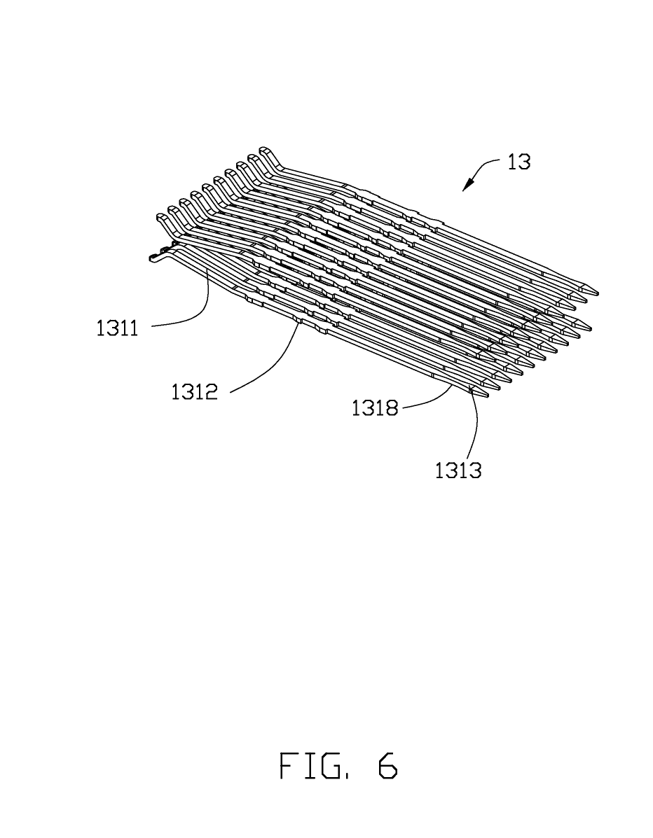

### DETAILED DESCRIPTION OF THE INVENTION

Reference will now be made in detail to the preferred embodiment of the present invention.

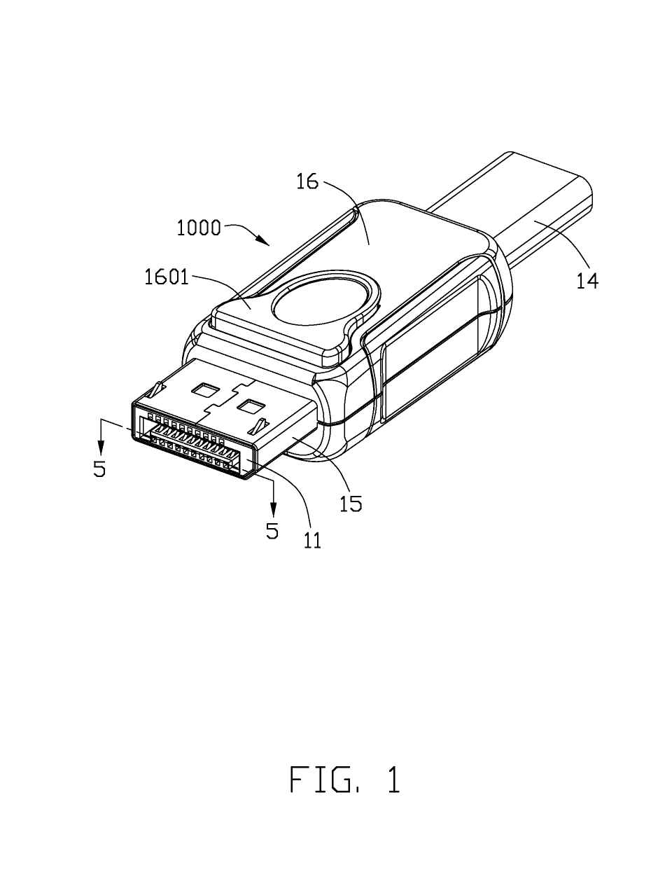

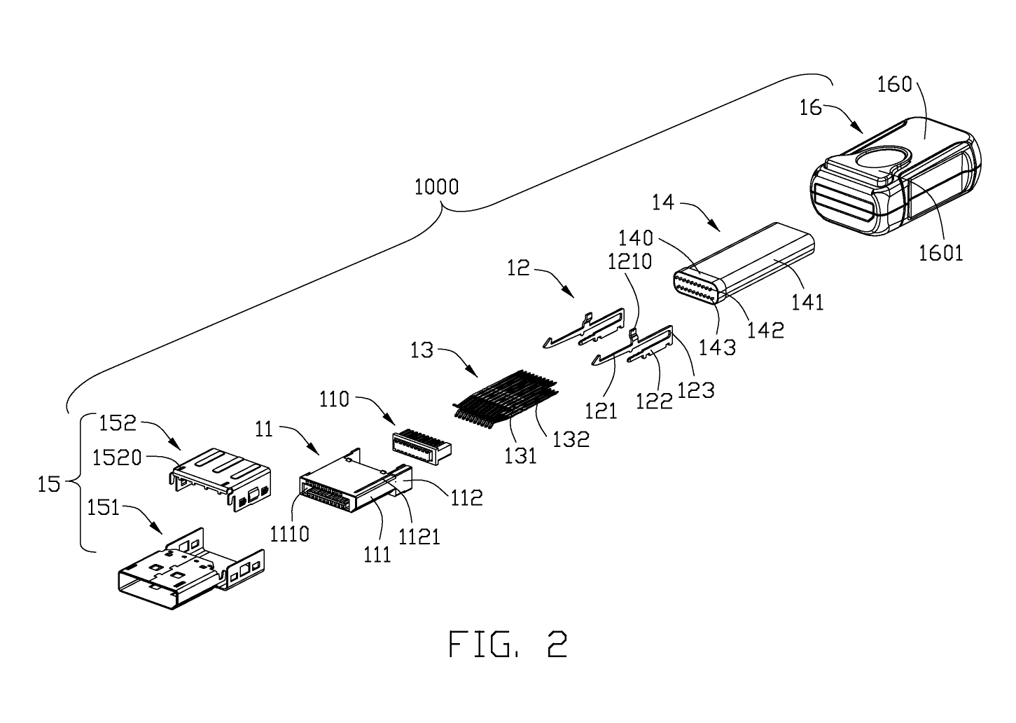

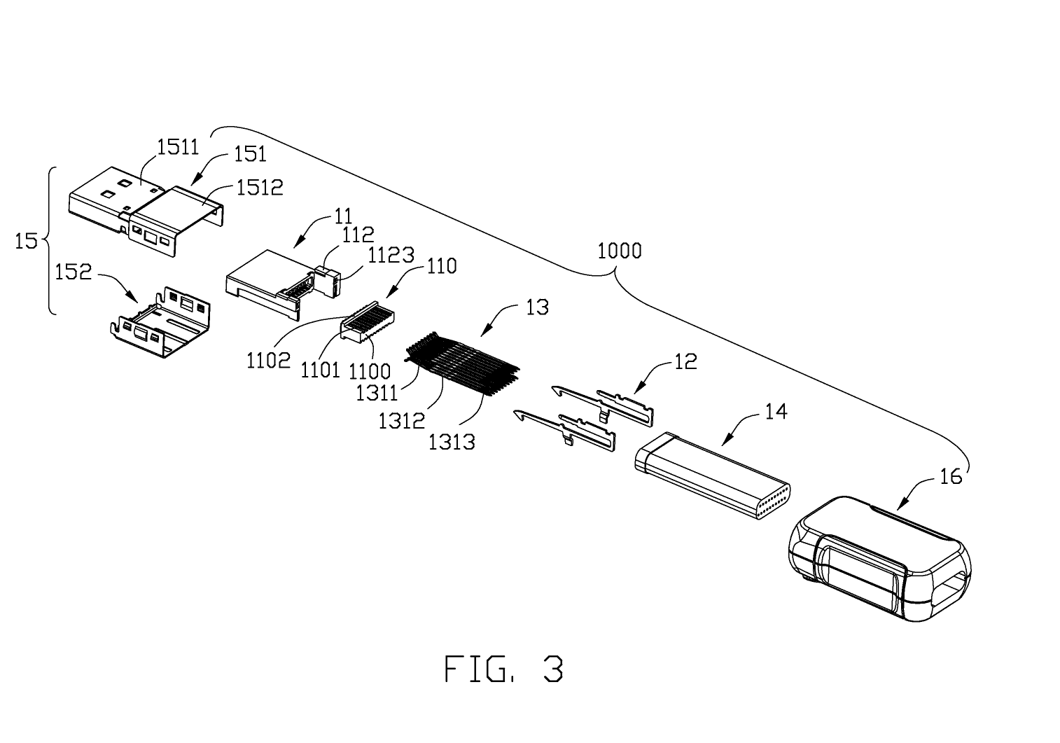

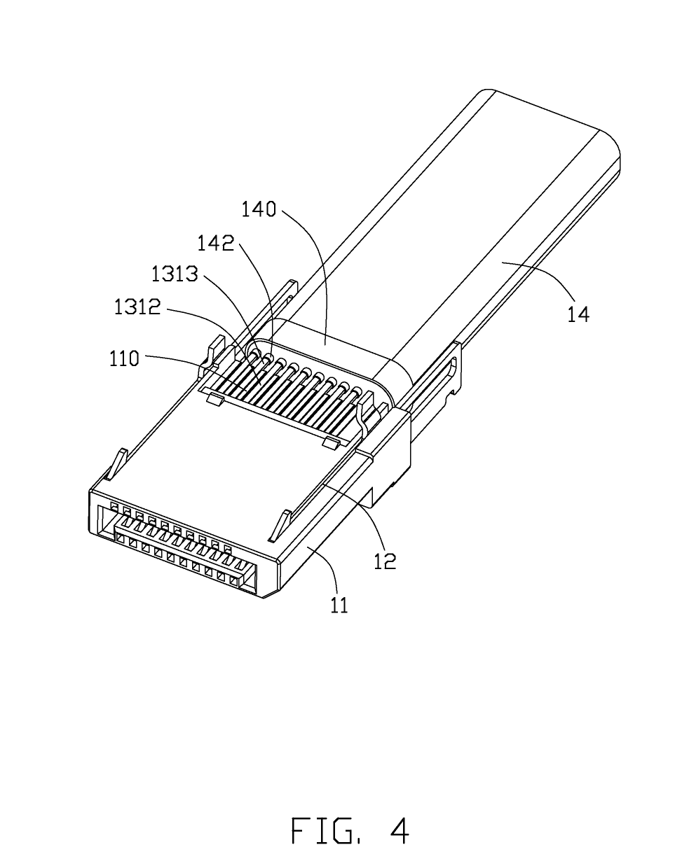

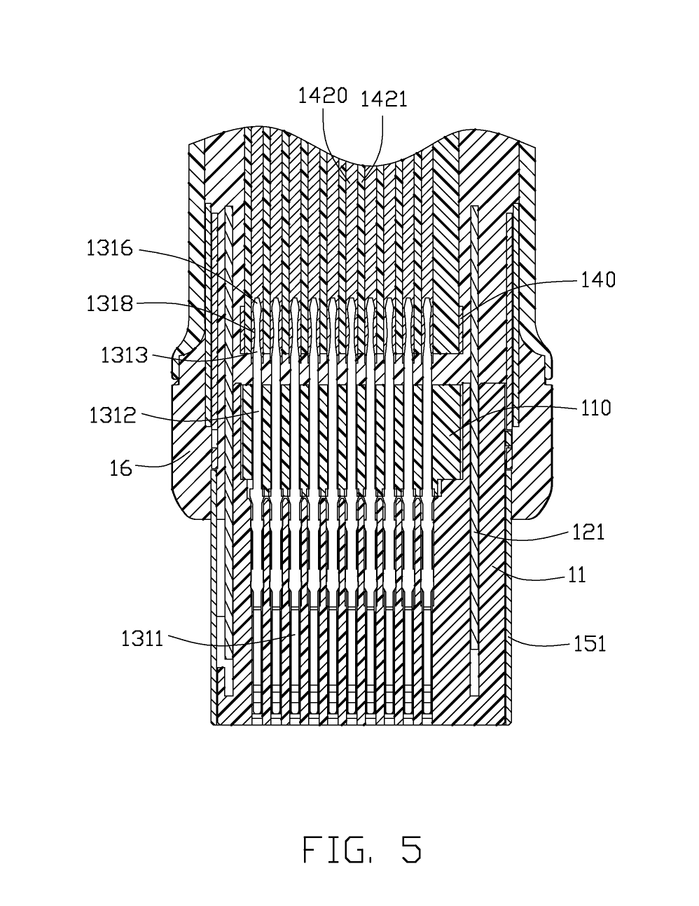

Referring to FIGS. 1-5, a cable assembly 1000 in accordance with the present invention comprises an insulative housing 11, a spacer 110, a pair of latching members 12, a plurality of contacts 13, a cable 14, a metallic shell 15 and an insulative cover 16.

The insulative housing 11 has a base portion 111 and two mounting arms 112 extending rearwardly from the base portion 111. The base portion 111 defines a recess 1110 extending along a longitudinal direction (front-to-back direction) and through the insulative housing 11. There is a longitudinal slot 1121 located in each mounting arm 112, and a positioning hole 1123 defined in an end of each mounting arm 112.

The spacer 110 has a rectangular shaped body portion 1100, a plurality of grooves 1101 respectively located in a top and bottom side of the body portion 1100, and two transversal bars 1102 respectively formed on the top side and the bottom side of the base portion 1100 and disposed adjacent to a front side of the body portion 1100. The grooves 1101 pass through the two transversal bars 1102.

Each latching member 12 includes a latching arm 121 extending along the longitudinal direction, and a retention arm 122 located under the latching arm 121 and arranged parallel to the latching arm 121, and a connection arm 123 connected to ends of the latching arm 121 and the retention arm 122. There is a tab 1210 formed at middle section of the latching arm 121 and projecting upwardly therefrom. The latching member 12 is mounted to the insulative housing 11, with the retention arm 122 retained in the positioning hole 1123, the latching arm 121 accommodated in the longitudinal slot 1121.

The contacts 13 are divided into a first contacts 131 and a second contacts 132 both arranged in a transversal row and distinct from each other along an up-to-down direction which perpendicular to the longitudinal direction. Each of the first contacts 131 includes a mating portion 1311, a retention portion 1312 extending backwardly from the mating portion 1311 and a tail portion 1313 also backwardly extending from the retention portion 1312. Each tail portion 1313 has a tapered/sharp end 1316. In addition, there are two cutouts 1318 respectively defined at opposite sides of the tail portion 1313 and spaced each other along a transversal direction. The cutout 1318 is arc shaped, with middle segment thereof is larger than a front and a back segment thereof Thus, there are two tapered sections along a front-to-back direction viewed from a top side, i.e. one of the tapered sections is the tapered end 1316, and the other tapered section is a corresponding section between the two cutouts 1318 which is located in front of the tapered end 1316. However, the cutout 1318 may be rectangular shape or other shapes. The second contacts 132 are same with the first contacts 131 and detailed description is omitted hereby.

The first contacts 131 and the second contacts 132 are respectively assembled to the top side and the bottom side of the spacer 110, with mating portions 1311 of the contacts 13 extending beyond the front side of the body portion 1100, the tail portions 1313 disposed behind a back side of the body portion 1100 and the retention portions 1312 positioned in the grooves 1101 respectively and held by the transversal bars 1102. The spacer 110 is inserted into a back section of the recess 1110, with the mating portions 1311 exposed in a front section of the recess 1110.

The cable 14 is a flat type cable and has a plurality of wires arranged into first wires 142, second wires 143 spaced apart from each other along a up-to-down direction and an insulative jacket 141 enclosing the first wires 142 and a second wires 143. The first wire 142 has an inner conductor 1420 and an insulative layer 1421 shielding the inner conductor 1420. The second wires 143 have similar structure to the first wires 142, and detailed description of the second wires 143 is omitted hereby.

The first wires 142 are aligned with the tail portions 1313 of the first contacts 131, and tail portions 1313 are respectively inserted/penetrated into the corresponding wires 142 along an axial direction, and the tail portions 1313 respectively contact the inner conductor 1420 along the axial direction to form electrical connection therebetween. The second wires 143 are engaged with the second contacts 132 with same manner as the first wires 142 with the first contacts 131. In addition, there is a ferrule 140 mounted to/crimped to the insulative jacket 141 and surrounding the cutouts 1318 of the first contacts 131. Thus, the insulative layer 1421 is deformed toward the cutout 1318 and retaining/engaging force between the wires and the contacts is increased.

The metallic shell 15 includes a first shell 151 and a second shell 152. The first shell 151 has a frame portion 1511 and an inverted U-shaped accommodating portion 1512. The second shell 152 is a U-shaped structure and can be assembled to the inverted U-shaped accommodating portion 152. The base portion 111 of the insulative housing 11 is received in the frame portion 1511. The cable 14 and the spacer 110 are sandwiched between the inverted U-shaped accommodating portion 1512 of the first shell 151 and the second shell 152.

The insulative cover 16 is assembled to the metallic shell 15 and holds the cable 14. Also, the latching members 16 are enclosed within the insulative cover 16. There is deformable button 1601 formed on a front section of an upper side 160 of the insulative cover 16. The deformable button 1601 is located above the tabs 1210 of the latching arms 121 and proximate to the tabs 1210. The deformable button 1601 can enter an interior of the insulative cover 16 to press the tabs 1210 and urge the latching arms 121 into the longitudinal slot 1121.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A cable assembly, comprising:
an insulative housing;
a plurality of contacts received in the insulative housing, each contact having a mating portion, a retention portion extending backwardly from the mating portion and a tail portion extending backwardly from the retention portion, the tail portion having a tapered end and at least one cutout defined thereon;
a cable having an insulative jacket and a plurality of wires enclosed by the jacket, each wire having an inner conductor and an insulative layer shielding the inner conductor; and
wherein the tail portions of the contacts are respectively penetrated into the wires along an axial direction.

2. The cable assembly as claimed in claim 1, wherein the cutout is disposed in front of the tapered end.

3. The cable assembly as claimed in claim 2, wherein the tapered end is disposed adjacent to the cutout.

4. The cable assembly as claimed in claim 1, wherein the cutout is an arc shape.

5. The cable assembly as claimed in claim 1, wherein the cutout has a middle segment larger than a front and back segment thereof.

6. The cable assembly as claimed in claim 1, wherein there are two cutouts defined at opposite sides of the tail portion.

7. The cable assembly as claimed in claim 1, wherein there is a ferrule crimped to the insulative jacket and surrounding the cutouts of the contacts.

8. A cable assembly, comprising:
an insulative housing defining a recess extending along a front-to-back direction;
a plurality of contacts retained with the insulative housing, with tail portions backwardly extending beyond the insulative housing, each tail portion having two tapered sections along a front-to-back direction;
a cable having plurality of wires enclosed in an insulative jacket thereof, each wire having an inner conductor continually contacting with the two tapered sections of the tail portion along an axial direction.

9. The cable assembly as claimed in claim 8, wherein the tail portion of the contact has a tapered end and two cutouts defined at opposite sides of the tail portion and located in front of the tapered end.

10. The cable assembly as claimed in claim 9, wherein the cutouts are arc shape and the two tapered sections are defined between the two cutouts and the tapered end of the tail portion.

11. The cable assembly as claimed in claim 8, wherein the contacts are divided into two groups along a up-to-down direction, and cable is a flat cable with wires thereof divided into two groups corresponding to the contacts.

12. The cable assembly as claimed in claim 11, wherein there is a ferrule crimped to insulative jacket of the cable and surrounding the tail portions of the contacts.

13. The cable assembly as claimed in claim 11, wherein there is a spacer assembled with the contacts and mounted to a back section of the recess.

14. The cable assembly as claimed in claim 13, wherein there are a plurality of grooves respectively located in a top and bottom side of a body portion of the spacer to position the contacts.

15. The cable assembly as claimed in claim 14, wherein there are two transversal bars respectively formed on the top side and the bottom side of the body portion to hold the contacts.

16. A cable connector assembly comprising:
an insulative housing defining two rows of passageways extending along a front-to-back direction and further defining a mating cavity in a front portion of the housing;
an insulative spacer attached to a rear side of the housing and defining two rows of grooves in alignment with the corresponding passageways, respectively, in the front-to-back direction;
a plurality of contacts each defining middle retention portion retained in the corresponding passageway, a front deflectable mating section exposed into the mating port, and a rear tail section received in the correspond groove with a lance at a rear end; and
a cable located behind the spacer and enclosing two rows of wires in alignment with the corresponding grooves, respectively, in the front-to-back direction so as to have the lance of each of the contacts pierce thereinto;
wherein
the lance of each of said contacts defines an inwardly curved waist section on two lateral sides so as to not ease insertion of the lance into the corresponding wire but also enhance retention between the lance and the corresponding wire in the front-to-back direction.

17. The cable connector assembly as claimed in claim 16, wherein in each of the contacts, the retention section is aligned with the corresponding tail including the corresponding lance thereof in the front-to-back direction so as to facilitate insertion of the lance in the corresponding wire. Page 11 of 12
